(19) United States
(12) Patent Application Publication
(10) Pub. No.: US 2019/0093877 A1
(43) Pub. Date: Mar. 28, 2019

(54) PORTABLE MULTIPLE-PURPOSE MAKEUP ORGANIZER APPARATUS

(71) Applicant: Steve Soffer, Los Angeles, CA (US)

(72) Inventor: Steve Soffer, Los Angeles, CA (US)

(21) Appl. No.: 15/719,207

(22) Filed: Sep. 28, 2017

(51) Int. Cl. F21V 33/00; F21L 4/02; H02J 50/10; H02J 7/02; A45D 42/10; A45D 44/00

(52) U.S. Cl. CPC F21V 33/0004; F21L 4/02; H02J 50/10; F21Y 2115/10; A45D 42/10; A45D 44/00; H02J 7/025

(57) ABSTRACT

A multiple-purpose makeup organizer includes a housing, a cover, the cover is operably attached to the housing whereby the cover opens and closes and thereby exposing an interior of the housing when the cover is open, an attachment mechanism, wherein the attachment mechanism is operably attached to a surface of the housing, the attachment mechanism attaches the housing to another surface, a light source operably attached to the housing, a battery, and a microcontroller operably in electrical communication with the light source.

### BACKGROUND OF THE INVENTION

### Field of the Invention

The present invention relates to multiple-purpose makeup organizers and makeup lighting. More specifically, the invention relates to a portable multiple-purpose makeup apparatus.

### Description of Related Art

There are many existing containers of different sizes and shapes that hold a variety of makeup items. A user may utilize a container for the purpose of storing and organizing makeup items such as mascara, lipstick, blush, makeup brushes and other items. Some containers have multiple compartments to facilitate organizing makeup items. Some containers also serve as a portable carrying device for transporting makeup.

Frequently, makeup is applied in front of a mirror where the user may be able to see how the makeup is applied. Typically, this occurs in rooms like bathrooms, bedrooms, hotel rooms, dorm rooms, gym locker rooms or other rooms, that in many cases have inadequate counter space. With users acquiring more and more cosmetics, counter space is at a premium and this has led to clutter. As such, there is a need for makeup containers that organize items without taking up much needed counter space.

In most cases, existing makeup containers are either stationary, and designed for organizing and storing makeup at home or designed for portability to take makeup on a trip, to the gym or another exercise facility. This requires the user who is traveling or going to the gym to either transfer their makeup from one type of organizer to the other, or alternatively have two sets of makeup.

In addition, there are situations where makeup must be applied in less than ideal lighting environments. Environments exist all too frequently that have inadequate amount of light or improper type of lighting and may result in the poor application of makeup or incorrect makeup choices.

All makeup users require good lighting in order to ensure that they have optimally applied their makeup. Choosing the right products and colors, and being able to accurately apply them are dependent on proper lighting to make good choices and see clearly when applying makeup.

In addition, professionals in the fashion or entertainment industry who work on photoshoots, motion pictures, fashion shows, personal appearances, or other professional situations, require a proper lighting environment that the location bathroom or dressing room may not have. As such, when makeup is applied it may be applied improperly because of poor lighting.

Moreover, existing makeup organizers don't address another user inconvenience. The user has to frequently shift their gaze away from what they are doing in the mirror to the counter top in order to pick up a different brush or the next makeup product. This disrupts and therefore slows down the makeup application process and since it is repeated numerous times it can be an inconvenience.

Existing makeup containers are bulky and take up a lot of counter space. They are either large and stationary or small and portable. They do not provide lighting, and certainly not correct lighting. In addition, they do not address the inconvenience of having the makeup application process disrupted.

To overcome the shortcomings of existing makeup containers, the present invention provides in one or more embodiments a makeup organizer to mitigate or obviate the aforementioned problems. In addition, embodiments of the present invention provide a makeup container that is easy to use, has numerous compartments for different types of makeup items, does not take up counter space, is portable, has controllable lighting modes for different lighting environments, is able to attach to a surface off the counter, helps minimize the inconvenience of reaching for items on the counter and is therefore significantly more effective than what is currently available.

### SUMMARY OF THE INVENTION

The present disclosure is directed to various embodiments of a portable multiple-purpose makeup organizer and controllable lighting source. The multiple-purpose makeup organizer includes a housing; a cover that is operably attached to the housing whereby the cover opens and closes and thereby exposing an interior of the housing when the cover is open; when open, the cover provides additional shelf space; an attachment mechanism, wherein the attachment mechanism is operably attached to a surface of the housing, the attachment mechanism attaches the housing to another surface; a light source operably attached to the housing; a power source; and a microcontroller operably in electrical communication with the light source.

The multiple-purpose container may include one or more removable compartments fitting inside the housing.

The light source may be at least one light emitting diode. At least one light emitting diode may be red, green, and blue to control the color of the light emitted and at least one light emitting diode may be white to control the brightness of the light emitted. The light source may be adjusted for daytime or evening lighting. The light source may be adjusted for full brightness. The light source may be adjusted to emulate a night light. The light source may be adjusted to control the color temperature.

The attachment mechanism may be a suction cup.

The multiple-purpose container may include a USB port or ports.

A mobile device may be operably connected to the makeup organizer to control the color temperature and light intensity by adjusting the light source.

A multiple-purpose makeup organizer includes a housing, a cover, wherein the cover is operably attached to the housing whereby the cover opens and closes and thereby exposing an interior of the housing when the cover is open, an attachment mechanism, wherein the attachment mechanism is operably attached to a surface of the housing, the attachment mechanism attaches the housing to another surface, a light source operably attached to the housing, a power source including a first inductive pickup coil, a microcontroller operably in electrical communication with the light source and the power source, and a charging station including a second inductive charging coil for wirelessly generating an electric current in the inductive pickup coil for the power source.

### BRIEF DESCRIPTION OF THE DRAWINGS

The features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1 is a front isometric view of an embodiment of a portable multiple-purpose makeup organizer;

FIG. 2A is a front plan view of an embodiment of the portable multi-purpose makeup organizer with the cover open;

FIG. 2B is a front isometric view of an embodiment of the portable multi-purpose makeup organizer with the cover open and a drawer extended;

FIG. 3 is a rear isometric view of an embodiment of the portable multi-purpose makeup organizer;

FIG. 4 is a front isometric view of an embodiment of the portable multi-purpose makeup organizer with light cover removed;

FIG. 5 is a top isometric view of the portable multi-purpose makeup organizer in accordance with one or more embodiments of the present invention;

FIG. 6 is a right side isometric view of the portable multi-purpose makeup organizer in accordance with one or more embodiments of the present invention; and

FIG. 7 is an illustration of an optional wireless charging unit for an embodiment of the portable multi-purpose makeup organizer.

### DETAILED DESCRIPTION

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof will not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

For the purpose of the present application the terms container, makeup container, bar, makeup bar, organizer, and makeup organizer are interchangeable. Light source, light element, and lights are used interchangeably and used to illustrate embodiments of the makeup organizer and is not intended to limit the makeup organizer but will only be used so in this application to describe an embodiment of the present invention.

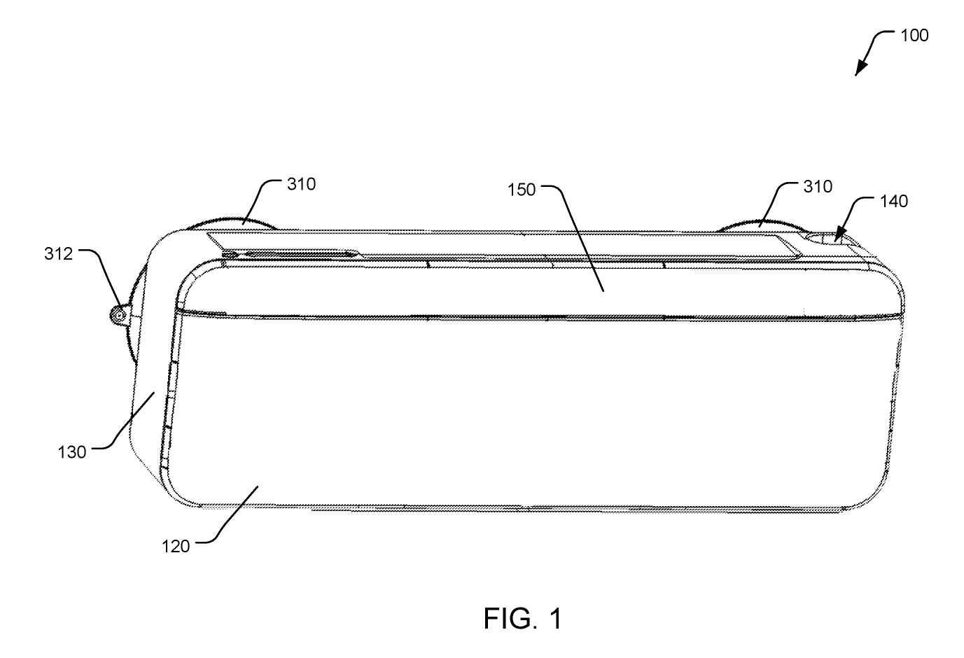

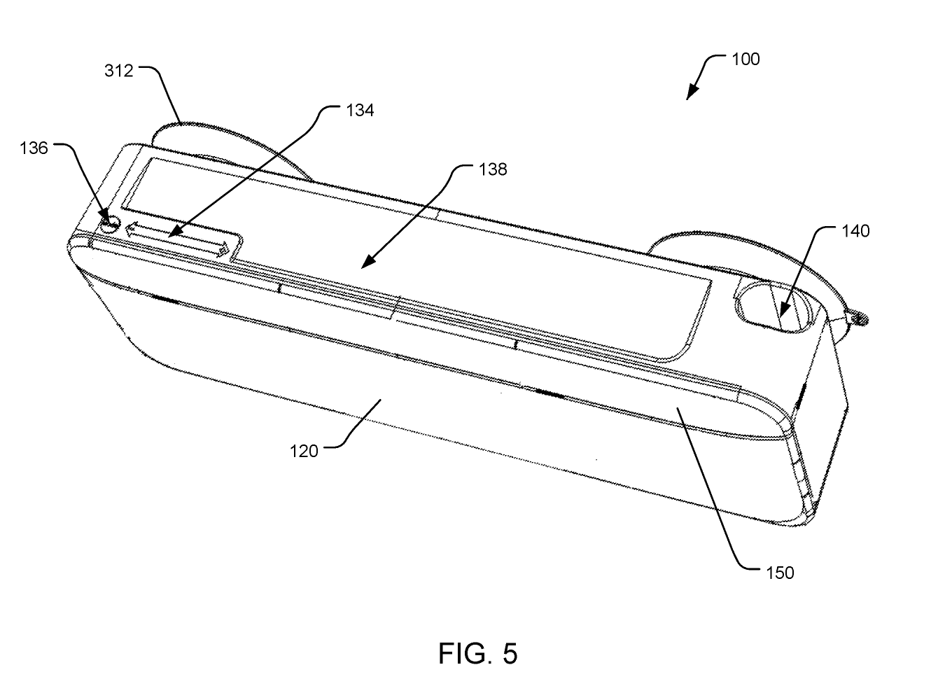

One or more embodiments of the present invention will now be described with reference to FIGS. 1-7.

Now referring to FIG. 1, is an isometric view of an embodiment of the present invention. The multiple-purpose container 100 may provide an easy solution to organize makeup and other items. The problem with previous containers is that they take up a lot of space on a counter and don't remove items from the counter that add to clutter. Moreover, a lot of times, lighting environments are bad and make it difficult for the user apply makeup properly and gauge how makeup would look in a different and better lighting conditions. The multiple-purpose container may allow for the user to attach the multiple-purpose container to a surface such as a bathroom or vanity mirror. This may allow the user to clear up space. Also, the multiple-purpose container may have a lighting element. Moreover, the lighting element may be controllable by the user.

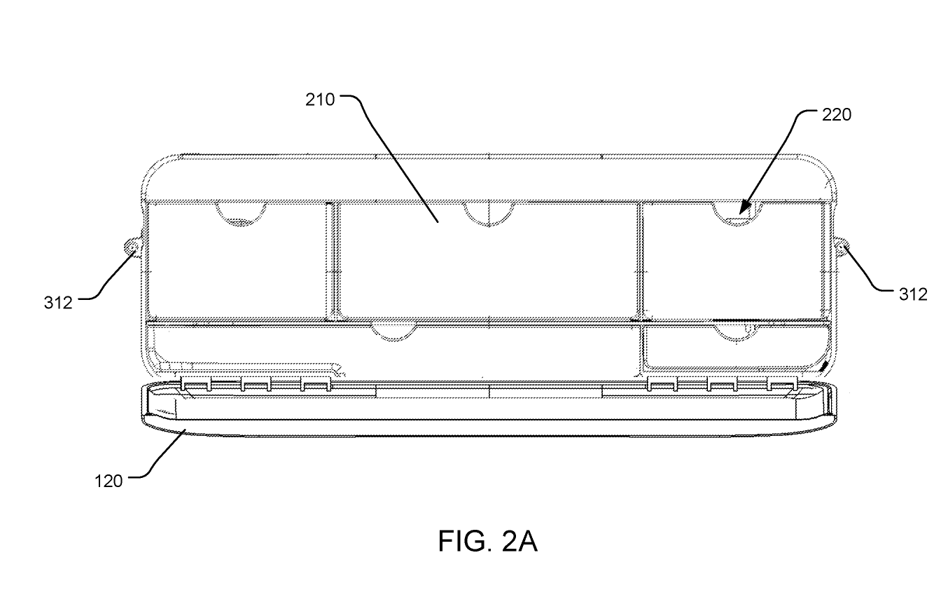

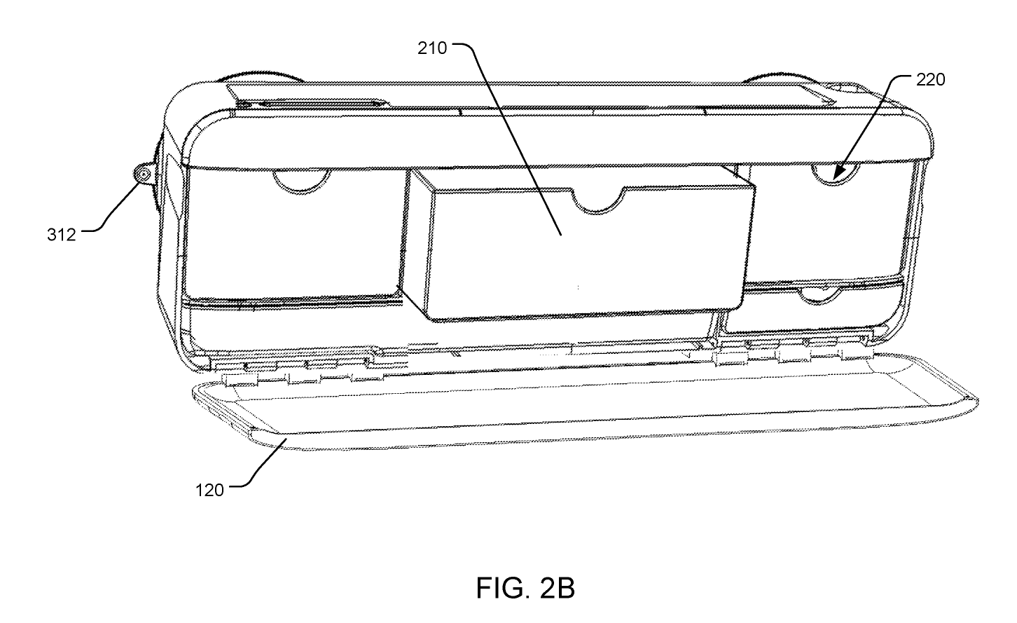

A multiple-purpose container 100 may include a housing 130 and a cover 120. The cover may be operably attached to the housing allowing the cover to open and close. When the cover is open, the interior of the housing may be exposed, as will be further discussed with respect to FIG. 2. In an embodiment, the housing may have a well or groove 140 for loose items. As a non-limiting example, the well 140 may be configured to hold makeup brushes, lipstick, or any other item the user may desire to have quick access.

The multiple-purpose container may be in a rectangular shape, however, it should not be limited to that particular shape. The container may be round, square, or any other shape imaginable. Moreover, the container may be made of plastic or other light-weight but strong material. The corners and edges may be rounded to enhance a smooth appearance and feel of the container, and to prevent snagging with clothing or other items. There may be grooves at the edge that meets the cover. The grooves may provide the user with a hold on the cover and, as such, may assist in the opening of the cover. In addition, the top of the container may include contours, e.g. trough 138, so that a cellular phone or any other device may be placed on top of the container. In addition, in one or more embodiments, the top may be coated with a material to enhance the grip of the surface. The coating may be an actual coating or it may be a layer of material to enhance the grip of the surface.

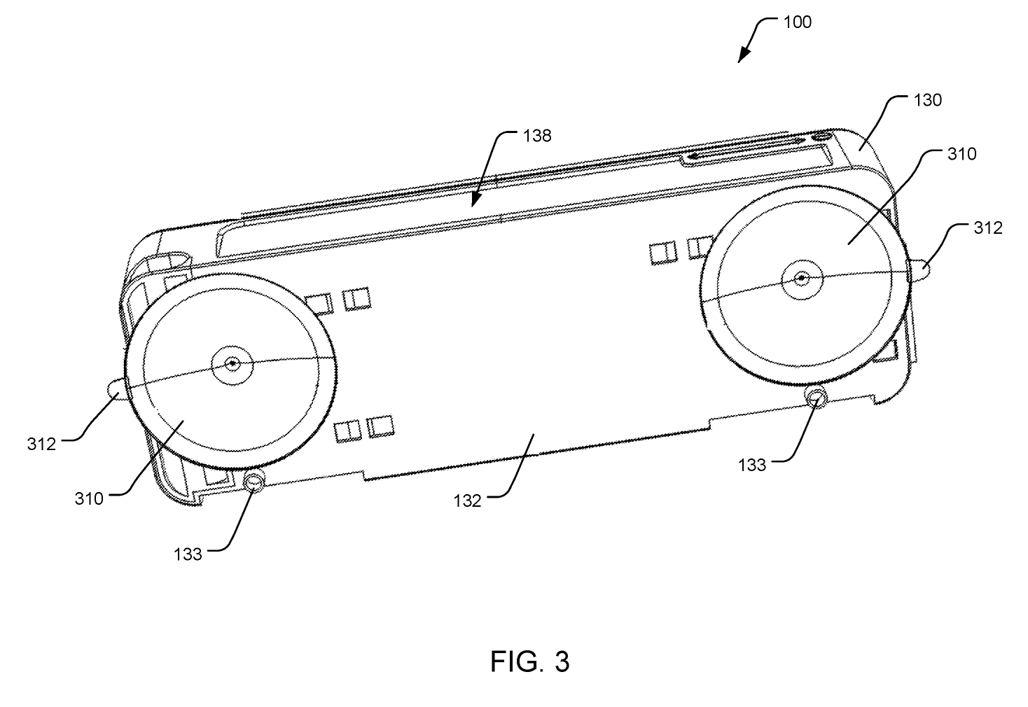

The multiple-purpose container may also have an attachment mechanism 310, as will be discussed in more detail with respect to FIG. 3. The attachment mechanism may be operably attached to a surface of the housing. The attachment mechanism may configured to attach the housing to a second surface, e.g. a fixed surface like a wall or a mirror. In one or more embodiments, the attachment mechanism comprises one or more suction cups. Each attachment mechanism 310 may include a tab or mechanism for disengagement, e.g. 312. For instance, the tab 312 may be configured such that pulling up on its edge results in disengagement of the suction cup from the second surface.

The multiple-purpose container may also have a light source comprising a diffuser 150 and one or more light emitting diodes operably attached to the housing. The light source may be configured for the light to be controllable by the user. Also, the multiple-purpose container may have a battery. The battery may be a lithium-ion battery or any other battery or power source that is capable of discharging power and then being able to be recharged. The battery may also be a disposable one-time use battery. In addition, the multiple-purpose container may have a microcontroller operably in electrical communication with the light source. The microcontroller may be a simple mechanism that may provide computing capabilities to control the different aspects of the container.

Now referring to FIGS. 2A and 2B, the multiple-purpose container may have removable compartments 210 fitting inside the housing. In the embodiment seen in FIG. 2A, there are five compartments, but there may be more or less compartments. The compartments may be in different shapes and sizes. Moreover, there may be an arcuate slice cutout, e.g. 220, in front of each compartment to aid in the sliding in and out of the housing as illustrated in FIG. 2B. The user may place items like lipstick, brushes, mascara, and other items of makeup or any other item inside. The user may be able to organize the items by separating them inside the different compartments.

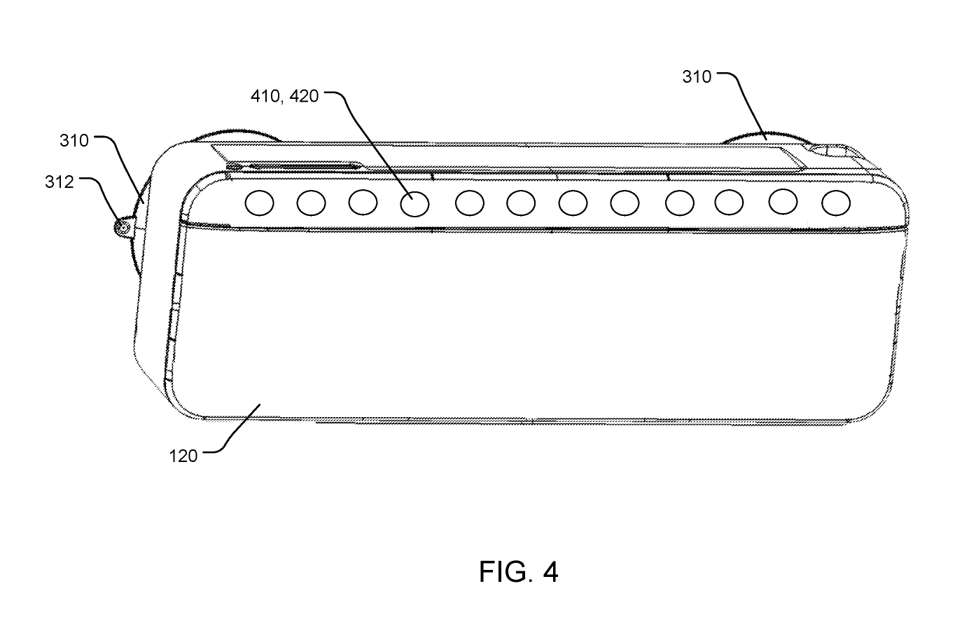

Now referring to FIG. 4, an embodiment of the multiple-purpose container with the light source exposed is presented. The light source may have a plurality of light emitting diodes, e.g. 410 and 420. The light source may comprise at least one light emitting diodes. The light source may be other sources of light such as cathode lamp, fluorescent lamp, neon lamp, xenon lamp or any other illuminating source. As a non-limiting example, at least one light emitting diode may be red, green, and blue, e.g. 410, to control the color of the light emitted and at least one light emitting diode may be white, e.g. 420, to control the brightness of the light emitted. There may be a plurality of red, green, and blue or white light emitting diodes. As such, the user may be able to control the tone of the light and the brightness and thereby create the right lighting for the particular situation.

In another embodiment, the light source may be adjustable for daytime or evening lighting using sliding switch 134 and one or more push-button or capacitive switches 136, or other controlling mechanism for example. As such, when the container is used during the daytime, the light source may not be required be as bright in order to illuminate an already bright environment. Moreover, the color tone may have to be adjusted to combat harsh natural light. In another embodiment, the light source may be adjusted for evening lighting. Since the environment would already be darker, there may not be a need for bright light. As such, the light source may be adjusted to diminish the intensity of the brightness and then the user may adjust the color tone to the desired lighting condition. As another non-limiting example, the light source may be adjusted for full brightness. The color tone function may be diminished but the white light would be set at maximum intensity. This function may be used during extreme conditions where a full light may be needed for details. Then again, this function may be used as a light for the user to find something in the dark. In another embodiment, the light source may be adjusted to emulate evening light. This particular function may require the color tone to be turned down along with the brightness. By doing so, it may create a soft light for the user. In addition, the night light may have different colors such as blue, green, red, or any other combination. By doing so, it may create a soft color glow light. In another embodiment, the light source may be adjusted to control the color temperature. The brightness and color tone may be adjusted to highlight or emit the cool colors (i.e., bluish white) or emit the warm colors (e.g., yellowish white) and colors in between.

Now referring to FIG. 3, the container has an attachment mechanism 310 at the back surface 132. The attachment mechanism may be one or more suction cups 310, for example. In other embodiments, there may be more than one suction cup 310. By adding more suction cups to the container, the strength of the adhesion to the other surface may be increased. Each engagement mechanism may include a disengagement tab, e.g. 312, for effortlessly disengaging the container from the external surface. One or more support posts 133 provide stability of the container when attached to an external surface. As a non-limiting example, the container may be attached to a surface such as a mirror by using the suction cups. By attaching the container to a surface like a mirror, the makeup items would be placed in one place. As such, there may be less clutter on a surface like a bathroom counter where other type makeup containers may typically be placed. In addition, in other embodiments, a hook and loop fastener may be used where a surface would receive one part of a hook or loop and the other surface would receive the other part. By doing so, the container may be placed on another surface. Moreover, there may be other means of attaching the container to another surface, such as glue, magnets, etc.

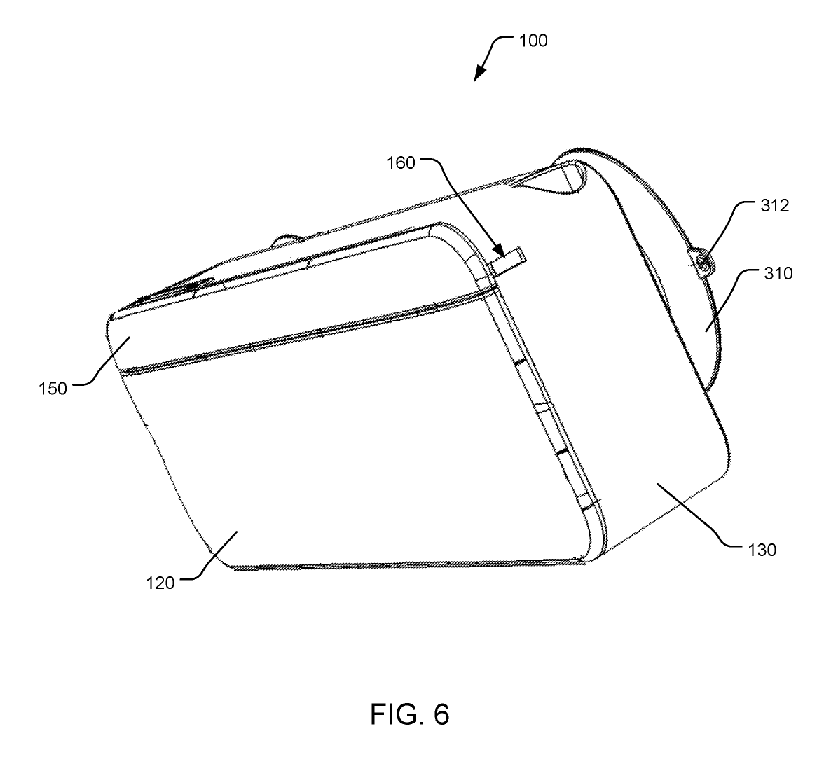

Now referring to FIG. 6, the container may include one or more USB ports 160. The USB port may be used to connect the container to an external power source, or for embodiments with internal batteries, the battery to an outside power source and thereby the battery may be charged. In other embodiments, the USB port may be used to operably communicate with a microcontroller in the container. On the other end of the cord may be a mobile device, a computer, or any other computing device which may be charged while in use with the makeup organizer. As such, the container's microcontroller may adjust the power settings, color/intensity level and any other function of the container.

The user may place items inside the compartments 210 or may remove the compartments altogether to store items. In other embodiments, the user may use the container without the compartments. If the user does use the compartments, the compartments are configured to be slideable in and out. Moreover, the user may open the cover 120 by pulling the cover down. In another embodiment, the cover may be pulled up and closed. In an embodiment, the cover may be attached to the housing by a hinge mechanism. As such, depending on where the hinge is located, the user may pull up or down the cover. Moreover, the attachment mechanism may be another mechanism that allows the cover to open and close or to be detached completely.

In another embodiment, the user may also adjust the light tone, intensity, and color to fit the desired lighting condition. The user may also attach the container to a surface such as a mirror in the bathroom, vanity, hotel or locker room. As such, the user may have direct access to the makeup in the container. Moreover, the user would not have to lose their focus while picking specific items from the container.

In another embodiment, the microcontroller of the multiple-purpose container may be controlled by a mobile device. The mobile device may be operably connected to the container to control the color temperature and light intensity by adjusting the light source. In yet another embodiment, the mobile device may control the different aspects of the container. As discussed previously, the container may be adjusted by the use of a computing device through a wire or cord. In one or more embodiments, the mobile device or computing device may wirelessly control the microcontroller.

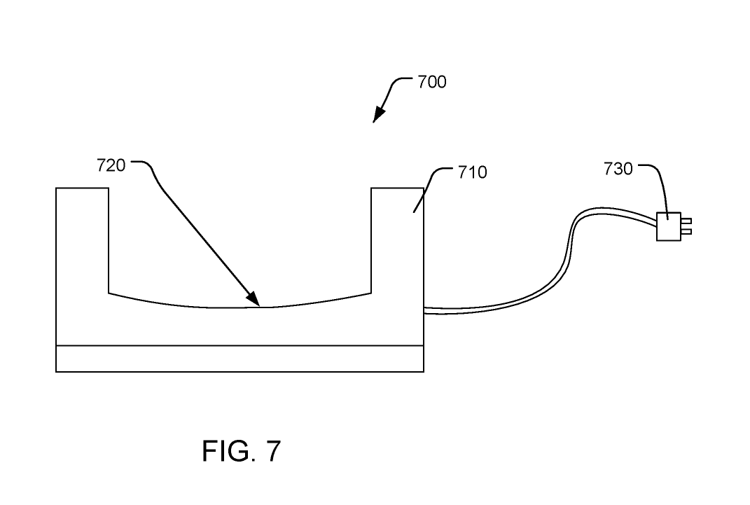

In another embodiment of the multiple-purpose container 100, the cover may be operably attached to the housing where the cover opens and closes and thereby exposing an interior of the housing when the cover is open. In another embodiment, the cover may have a compartment to store makeup items. The container may further include an attachment mechanism, where the attachment mechanism is operably attached to a surface of the housing and the attachment mechanism attaches the housing to another surface. The container may also include a light source operably attached to the housing. In this embodiment, the container may include a power source including a first inductive pickup coil. Moreover, the container may include a microcontroller operably in electrical communication with the light source and the power source. In addition, the container may include a charging station 700 comprising a second inductive charging coil for wirelessly generating an electric current in the inductive pickup coil for the power source, as illustrated in FIG. 7.

One or more embodiments may allow for wireless charging of the container. The charging station, e.g. 700, comprising a body 710 and cavity 720, may include a power plug 730 that attaches to a power source. As a non-limiting example, the power source may be a battery. As such, the wireless charger may charge the battery of the container when the container is placed on top of it, e.g. in cavity 720.

In another embodiment, a method of adjusting light from a multiple-purpose container includes a housing, a cover, where the cover is operably attached to the housing. The cover may open and close and thereby expose an interior of the housing when the cover is open. The container may include an attachment mechanism, the attachment mechanism is operably attached to a surface of the housing. The attachment mechanism may attach the housing to another surface. The container may further include a light source. The light source may be adjusted by adjusting a power source operably attached to the housing, supplying power, by a battery, and controlling, by a microcontroller operably in electrical communication with the light source.

The container of the embodiment described may include removable compartments fitting inside the housing. The light source described in the embodiment may include at least one light emitting diode.

Moreover, the light source described in the embodiment may include at least one light emitting diode that is red, green, and/or blue to control the color of the light emitted and at least one light emitting diode is white to control the brightness of the light emitted.

In another embodiment of the container, the light source may be adjusted for daytime or evening lighting. In another embodiment, the light source may be adjusted to control the color temperature. Moreover, in another embodiment, a mobile device may be operably connected to control the color temperature and light intensity by adjusting the light source.

The light source may be synchronized with music or be adjusted by a mobile phone or other application wherein the lights may have a pattern. Also, there may be speakers or some other sound system may be attached to or included with the container. With the combination of the speakers and lights, the experience may be controlled by a software application or other control device.

In another embodiment, a mobile device may be placed on top of the container and may be operably connected to the container. As a non-limiting example, the mobile device may be connected through the use of a USB cable to the container through the USB port. By doing so, the user may control the operations of the container. Moreover, the user may charge their mobile device's battery with the container.

In another embodiment, a mirror with lighting may be operably connected to the container. The mirror may be a magnifying type, for example.

In addition, the container may have different shapes. As non-limiting examples, a guitar, a particular animal, insect, airplane, cars, trains, or any other shape may be used. As another non-limiting example, the cover may have a mirror surface so when the cover is closed then the surface facing outward may act as a mirror for the user. The cover may also have one or more troughs on the inside surface for temporarily placing items while using the makeup organizer.

The container may provide a simplified construction that is movable. The simplification of the construction has several benefits and advantages over what is currently available. First, the simple construction may make it easier to use. Second, the invention may be portable thereby providing much needed space. Third, the invention may have controllable light functions. Last, the invention may be able to attach to a surface thereby creating more space for the user.

It should be understood that embodiments described herein should be considered in a descriptive sense only and not for purposes of limitation. Descriptions of features or aspects within each exemplary embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claim.

1. A multiple-purpose makeup organizer comprising:
a portable housing with an interior chamber defined by a plurality of panels comprising a left side panel, a right side panel, a back side panel, a top side panel, and a bottom side panel, wherein said interior chamber comprises one or more slideable drawer compartments accessible through an opening on a front side of said housing;
a cover hingedly coupled to secure said front side opening, wherein the cover is operably attached to the housing whereby the cover opens and closes and thereby exposing said interior chamber of the housing when the cover is open;
an attachment mechanism coupled to an external surface of one of said panels of the housing, wherein the attachment mechanism is configured to releasably couple the housing to a surface of an external structure;
a light source operably attached to an external surface of the housing;
a power source; and
a microcontroller operably in electrical communication with the light source.

2. The multiple-purpose organizer of claim 1, wherein said attachment mechanism is attached to said back side panel and comprises a tab for disengagement of said housing from said external structure.

3. The multiple-purpose organizer of claim 1, wherein the light source is at least one light emitting diode.

4. The multiple-purpose organizer of claim 3, wherein at least one light emitting diode is red, green, and blue to control the color of the light emitted and at least one light emitting diode is white to control the brightness of the light emitted.

5. The multiple-purpose organizer of claim 4, wherein the light source is adjustable for daytime lighting.

6. The multiple-purpose organizer of claim 4, wherein the light source is adjustable for evening lighting.

7. The multiple-purpose organizer of claim 4, wherein the light source is adjustable to full brightness.

8. The multiple-purpose organizer of claim 4, wherein the light source is adjustable to emulate a night light.

9. The multiple-purpose organizer of claim 4, wherein the light source is adjustable to control the color temperature.

10. The multiple-purpose organizer of claim 1, wherein the attachment mechanism is a suction cup.

11. The multiple-purpose organizer of claim 1, further comprising a USB port.

12. The multiple-purpose organizer of claim 1, wherein a mobile device is operably connected to control the color temperature and light intensity by adjusting the light source.

13. The multiple-purpose organizer of claim 1, wherein the power source is a battery.

14. A multiple-purpose organizer comprising:
a portable housing with an interior chamber defined by a plurality of panels comprising a left side panel, a right side panel, a back side panel, a top side panel, and a bottom side panel, wherein said interior chamber comprises one or more slideable drawer compartments accessible through an opening on a front side of said housing;
a cover hingedly coupled to secure said front side opening, wherein the cover is operably attached to the housing whereby the cover opens and closes and thereby exposing the interior chamber of the housing when the cover is open;
an attachment mechanism coupled to an external surface of the back side panel, wherein the attachment mechanism is configured to releasably couple the housing to an external structure;
a light source operably attached to an external surface of the housing;
a power source comprising a first inductive pickup coil; and
a microcontroller operably in electrical communication with the light source and the power source.

15. The multiple-purpose organizer of claim 14, further comprising a charging station at the top side panel of said housing comprising a second inductive charging coil for wirelessly generating an electric current in the inductive pickup coil for the power source.

16. The multiple-purpose organizer of claim 14, wherein the attachment mechanism is a suction cup.

17. The multiple-purpose organizer of claim 14, further comprising a USB port.

18. A multiple-purpose makeup organizer comprising:
a portable housing with an interior chamber defined by a plurality of panels comprising a left side panel, a right side panel, a back side panel, a top side panel, and a bottom side panel, wherein said interior chamber comprises one or more slideable drawer compartments accessible through an opening on a front side of said housing;
a cover hingedly coupled to said bottom side panel for securing said front side opening, wherein the cover is operably configured to open by pulling down on a handle thereby exposing the interior chamber of the housing when the cover is open;
a light source operably attached to an external surface on said front side of the housing;
a power source; and
a microcontroller operably in electrical communication with the light source.

19. The multiple-purpose organizer of claim 18, further comprising an attachment mechanism coupled to an external surface of the back side panel, wherein the attachment mechanism is configured for releasably coupling the housing to a surface of an external structure.
